(19) United States
(12) Patent Application Publication
(10) Pub. No.: US 2017/0269974 A1
(43) Pub. Date: Sep. 21, 2017

(54) SPECULATIVE EXECUTION OF A STREAM OF CHANGES

(71) Applicant: Hewlett Packard Enterprise Development LP, Houston, TX (US)

(72) Inventors: Vaibhav Arora, Palo Alto, CA (US); Alkis Simitsis, Santa Clara, CA (US); William K. Wilkinson, San Mateo, CA (US)

(73) Assignee: Hewlett Packard Enterprise Development LP, Houston, TX (US)

(21) Appl. No.: 15/529,375

(22) PCT Filed: Nov. 26, 2014
(86) PCT No.: PCT/US2014/067651

§ 371 Date: May 24, 2017

(51) Int. Cl. G06F 9/52; G06F 17/30

(52) U.S. Cl. CPC G06F 9/528; G06F 17/30362; G06F 17/30587

(57) ABSTRACT

Example implementations relate to speculative execution of a stream of changes. For example, a computing device may include at least one processor. The at least one processor may receive a stream of changes concurrently received by an online transaction processing (OLTP) database engine in communication with the computing device. The at least one processor may process the stream of changes based on speculative execution and verify that an order of the stream of changes processed based on speculative execution matches an OLTP order of the stream of changes committed by the OLTP database engine. The at least one processor may send the stream of changes processed based on speculative execution to an online analytical processing (OLAP) database engine to be stored in an OLAP database.

### BACKGROUND

Many entities (e.g., enterprises, organizations, computer applications, etc.) utilize databases for storage of data relating to the entities. The data in a database may be received from a data stream of incoming data. Data stored in these databases may be accessed and analyzed for various purposes.

### BRIEF DESCRIPTION OF THE DRAWINGS

Some examples of the present application are described with respect to the following figures:

FIG. 1 is a block diagram of an example hybrid database management system for speculative execution of a stream of changes;

FIG. 2 is a block diagram of a computing device for speculative execution of a stream of changes; and

FIG. 3 is a flowchart illustrating an example method of speculatively executing a stream of changes.

### DETAILED DESCRIPTION

As described above, data stored in a database may be accessed and analyzed for various purposes. A database management system (DBMS) may manage and control access to a particular database in response to queries for data. Typically, a DBMS may be optimized for a particular type of workload, such as online transaction processing (OLTP) or online analytical processing (OLAP). OLTP pertains to a class of information systems that may facilitate and manage transaction-oriented applications, such as data entry and retrieval transaction processing. OLAP is an approach to answering multi-dimensional analytical queries, such as business reporting. OLTP requests may be relatively short and may read or write only a few database records, while OLAP requests may be relatively long, may access a large number of records, and may allow primarily read-only access. The OLAP database may have copies of the data in the OLTP database. When changes are sent to the OLTP database, the changes are propagated to the OLAP database. However, there may be a delay in the propagation of the changes to an OLAP database, and as such, a query of the OLAP database may not always return the freshest data.

A hybrid DBMS having a synchronization engine may be utilized to optimize access to and/or modification of both an OLTP database and an OLAP database, providing a unified framework capable of handling both OLTP and OLAP workloads concurrently. In some examples, the features of the hybrid DBMS may be implemented as a module on top of existing OLTP and OLAP DBMSs. The OLTP and OLAP databases contain at least some common data, but the common data in each database may be stored in different representations, where the common data in the OLTP database may be the current version of the common data while the common data in the OLAP database may be either the current version or a previous version of the common data. The synchronization engine of the hybrid DBMS may manage the synchronization of modifications from the OLTP to the OLAP database to ensure that modifications to the OLTP database are propagated to the OLAP database and may provide access to data that is in-transit between the OLTP database and the OLAP database. An interface module of the hybrid DBMS may be used to interface the hybrid DBMS with one or more applications such that the hybrid DBMS may appear to the applications as a single DBMS.

A federation layer within the interface module of the hybrid DBMS may receive changes to be applied to the OLTP database and may forward those changes to the OLTP database engine as well as to the synchronization engine. For example, the changes forwarded to the OLTP database engine and the synchronization engine may include changes T₁, T_{z}, T₃, T₄, and T₅. The synchronization engine may tentatively process the changes using speculative execution. Speculative execution is a technique that may improve throughput by not waiting for a correct order for execution of operations. The synchronization engine may speculatively execute the changes, but the tentatively processed changes may not be committed to the OLAP database until the changes have been executed and committed by the OLTP database engine. Once the changes are executed and committed by the OLTP database engine, the synchronization engine may perform validation of the changes speculatively executed by the synchronization engine to verify that the order of those changes matches the order of the changes executed and committed by the OLTP database engine.

For example, OLTP database engine may have executed and committed changes T₁-T₅ in the following order: T₃, T₂, T₅, T₁, T₄. If the order in which the synchronization engine speculatively executed the changes is the same as the order in which the OLTP database engine executed and committed the changes, the speculatively executed changes may be validated. If the changes are validated, the changes are sent in a batch from the synchronization engine to the OLAP database engine such that the changes may be stored in the OLAP database. The speculative execution preprocessing performed by the synchronization engine may enable the changes to be applied to the OLAP database more quickly, allowing the results of the changes to be made available to analytic queries requesting fresh data.

In some examples involving interactive transactions, the federation layer may coordinate the exchange of intermediate results and subsequent commands between the application program, the OLTP database engine, and the synchronization engine. For example, assuming a change Tᵢ comprises multiple sets of commands Tᵢ₁, Tᵢ₂, . . . , Tᵢₖ, where each Tᵢⱼ₊₁ change is sent by the application program to the federation layer after the application program receives the results of Tᵢⱼ. An approach may be to ignore intermediate results (e.g., results for Tᵢⱼ) from speculative execution and not forward those results to the application program. When the next set of commands (e.g., Tᵢⱼ₊₁) is received from the application program, both sets of commands (e.g., Tᵢⱼ and Tᵢⱼ₊₁) may be sent to both the OLTP database engine and the synchronization engine. In some examples, the federation layer may receive the intermediate results for Tᵢⱼ from the synchronization engine and compare these results to the intlermediate results for Tᵢⱼ from the OLTP database engine. If any differences occur, the synchronization engine may determine an out-of-order execution for Tᵢⱼ and may take any suitable action, such as not speculatively executing additional changes for Tᵢ.

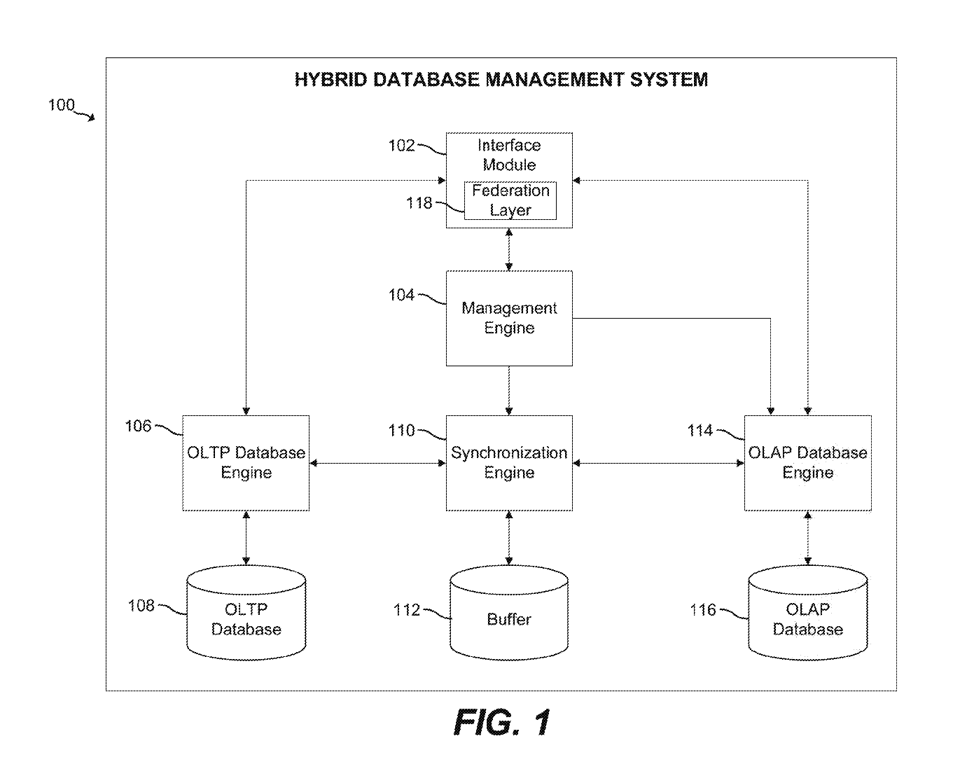

Referring now to the figures, FIG. 1 is a block diagram of an example hybrid DBMS 100 for speculative execution of a stream of changes. The components of hybrid DBMS 100 may operate using one or more processors (not shown) to perform the functions of the components.

Interface module 102 is a hardware-implemented and/or processor-implemented module that provides one or more unified application programming interfaces (APIs) to any applications to allow communication between the applications and hybrid DBMS 100. Interface module 102 may maintain session and transaction context, accept requests for data, forward those requests to the appropriate DBMS (e.g., OLTP database engine 106 or OLAP database engine 114) for processing, and return results in response to the requests.

OLTP database engine 106 is a hardware-implemented and/or processor-implemented module that manages and controls writing data to OLTP database 108, reading data from OLTP database 108, and processing OLTP requests. OLTP database 108 may be any suitable database optimized for OLTP. While examples disclosed herein describe an OLTP database engine and an OLTP database, one of ordinary skill in the art will recognize that any suitable write-optimized database engine and write-optimized database may be used with the techniques described herein.

OLAP database engine 114 is a hardware-implemented and/or processor-implemented module that manages and controls writing data to OLAP database 116, reading data from OLAP database 116, and processing OLAP requests. OLAP database 116 may be any suitable database optimized for OLAP. While examples disclosed herein describe an OLAP database engine and an OLAP database, one of ordinary skill in the art will recognize that any suitable read-optimized database engine and read-optimized database may be used with the techniques described herein.

Federation layer 118 is a hardware-implemented and/or processor-implemented layer within interface module 102 that may manage and control the receipt of a stream of changes from an application and the transfer of the stream of changes to both OLTP database engine 106 and synchronization engine 110. For example, when a stream of changes is received by hybrid DBMS 100, federation layer 118 may send the stream of changes to both OLTP database engine 106 and synchronization engine 110.

Synchronization engine 110 is a hardware-implemented and/or processor-implemented module that may manage and control the synchronization of data between OLTP database engine 106 and OLAP database engine 114. In some examples, synchronization engine 110 may collect changes to table rows in OLTP database 108 from OLTP database engine 106, cache the changes locally in buffer 112, and load the changes to the OLAP database engine 114 for storage in OLAP database 116 at the appropriate time and/or in the appropriate manner based on specified criteria. In some examples, synchronization engine 110 may receive a stream of changes from federation layer 118, process the stream of changes based on speculative execution, and store the speculatively executed stream of changes in buffer 112. Buffer 112 may be any suitable storage device capable of storing changes. In some examples, buffer 112 may be a high-performance main memory buffer capable of storing speculatively executed changes. Synchronization engine 110 may also provide query capability over in-transit data that may be stored in buffer 112 but not yet loaded to OLAP database engine 114.

Synchronization engine 110 may further manage and control validation of changes that have been speculatively executed to ensure that an order associated with the speculatively executed changes matches an order of changes committed by OLTP database engine 106. For example, synchronization engine 110 may verify whether the order of speculatively executed changes match an order for changes that have been committed by OLTP database engine 106. If the changes are validated, the speculatively executed changes may be sent to OLAP database engine 114 in a batch such that the changes may be committed to OLAP database 116.

In some examples, synchronization engine 110 and buffer 112 may be part of OLAP database engine 114. This may allow changes to be ingested more quickly into the OLAP database 116 since the changes are preprocessed on OLAP database engine 114. In other examples, synchronization engine 110 and buffer 112 may be separate from OLAP database engine 114.

Management engine 104 is a hardware-implemented and/or processor-implemented module that provides various management functions, such as managing criteria specifying a manner of sending changes from buffer 112 to OLAP database engine 114 for storage in OLAP database 116, determining when and/or how to initiate transfer of changes from buffer 112 to OLAP database engine 114 for storage in OLAP database 116, managing garbage collection of old data, and the like.

As described above, speculative execution may be used to preprocess changes received at synchronization engine 110 from federation layer 118. These changes may be speculatively executed in parallel to being executed at OLTP engine 106. Control messages may be sent from OLTP database engine 106 to synchronization engine 110 to convey the order of the committed changes at the OLTP database engine 106. If the order of the speculatively executed changes is the same as the order of the committed changes at the OLTP database engine 106, the speculatively executed changes may be committed by sending them as a batched transaction to the OLAP database engine 114. If the executed changes do not match, the speculatively executed changes may be rolled back, re-executed in the appropriate order, and sent to the OLAP database engine 114. Synchronization engine 110 may perform verification of transaction order for a batch of transactions. The number of transactions in a batch may be any suitable number and may be variable and changed based on the workload.

In some examples, synchronization engine 110 may speculatively execute changes based on a concurrency control scheme used at OLTP database engine 106. The changes may be speculatively executed based on any suitable concurrency control scheme used at OLTP database engine 106. This may decrease the probability of the speculative execution order being different from the order of committed changes at the OLTP database engine 106. In some examples, if MySQL is used as the OLTP database 108, the concurrency control scheme used at buffer 112 may be two-phase locking (2PL). Since row-level locking may be performed, storing buffer 112 as a row database store may be advantageous. In some examples, if VoltDb is used as the OLTP database 108, buffer 112 may follow a singled threaded execution scheme on each partition like VoltDb.

Changes whose final order has been defined by OLTP database engine 106 may be committed to OLAP database engine 114 using any suitable techniques. In some examples, if synchronization engine 110 has access to tuple identifiers in OLAP database engine 114, synchronization engine 110 may apply the effect of changes to be committed. Since the changes have already been executed on buffer 112, this technique may allow synchronization engine to apply the transactional effects as row-level changes to OLAP database engine 114. In some examples, synchronization engine 110 may convert any update and/or delete operations to insert operations before sending the changes to OLAP database engine 114. In some examples, since the speculatively executed changes may be executed in a batch, the operations of a batch may be applied as a single transaction.

Federation layer 118 may send any read-only analytical queries to OLAP database engine 114. Since the changes may only be committed to OLAP database engine 114 once the final order is determined and validated, analytical queries may see a consistent view of the data and produce correct results. In some examples, a user may have an option to run an analytical query over uncommitted results from speculatively executed changes in buffer 112. This may allow a user to view the freshest data, even though the data may include results that might be rolled back later based on validation. This may benefit applications that do not have strict consistency requirements but that may wish to see the freshest data.

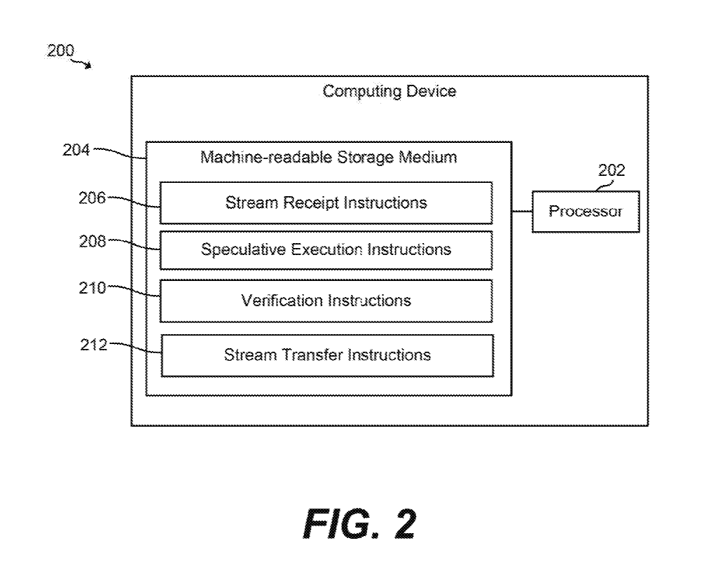

FIG. 2 is a block diagram of an example computing device 200 for speculative execution of a stream of changes. In some examples, computing device 200 may be a synchronization engine, such as synchronization engine 110 of FIG. 1.

Computing device 200 may be, for example, a web-based server, a local area network server, a cloud-based server, a notebook computer, a desktop computer, an al-in-one system, a tablet computing device, a mobile phone, an electronic book reader, a printing device, or any other electronic device suitable for speculative execution of a stream of changes. Computing device 200 may include a processor 202 and a machine-readable storage medium 204. Computing device 200 may receive a stream of changes concurrently received by an OLTP database engine, speculatively execute the stream of changes, validate the speculatively executed changes, and send those changes to an OLAP database engine.

Processor 202 is a tangible hardware component that may be a central processing unit (CPU), a semiconductor-based microprocessor, and/or other hardware devices suitable for retrieval and execution of instructions stored in machine-readable storage medium 204. Processor 202 may fetch, decode, and execute instructions 206, 208, 210, and 212 to control a process of speculatively executing of a stream of changes. As an alternative or in addition to retrieving and executing instructions, processor 202 may include at least one electronic circuit that includes electronic components for performing the functionality of instructions 206, 208, 210, 212, or a combination thereof.

Machine-readable storage medium 204 may be any electronic, magnetic, optical, or other physical storage device that contains or stores executable instructions. Thus, machine-readable storage medium 204 may be, for example, Random Access Memory (RAM), an Electrically Erasable Programmable Read-Only Memory (EEPROM), a storage device, an optical disc, and the like. In some examples, machine-readable storage medium 204 may be a non-transitory storage medium, where the term “non-transitory” does not encompass transitory propagating signals. As described in detail below, machine-readable storage medium 204 may be encoded with a series of processor executable instructions 206, 208, 210, and 212 for receiving a stream of changes concurrently received by an OLTP database engine, speculatively executing the stream of changes, confirming and/or verifying that an order of the stream of changes speculatively executed matches an OLTP order of the stream of changes committed by the OLTP database engine, and sending and/or committing the stream of changes speculatively executed to an OLAP database via an OLAP database engine.

Stream receipt instructions 206 may manage and control receipt of a stream of changes. The stream of changes may be changes concurrently received by an OLTP database engine such that the changes may be applied to the OLTP database. For examples, the stream of changes may include updates, insertions, and/or deletions associated with the OLTP database.

Speculative execution instructions 208 may manage and control the processing of the stream of changes based on speculative execution. For example, the stream of changes may be speculatively executed based on any suitable criteria. In some examples, the stream of changes may be speculatively executed based on a concurrency control scheme of the OLTP database engine.

Verification instructions 210 may manage and control the verification and/or confirmation of an order of the stream of changes that are speculatively executed by speculative execution instructions 208. For example, verification instructions 210 may verify and/or confirm that an order of the stream of changes speculatively executed matches an OLTP order of the stream of changes committed by the OLTP database engine.

Stream transfer instructions 212 may manage and control the sending and/or committing of the stream of changes speculatively executed to the OLAP database using the OLAP database engine. For example, stream transfer instructions 212 may send and/or commit the stream of changes to an OLAP database upon verification and/or confirmation of the speculatively executed stream of changes.

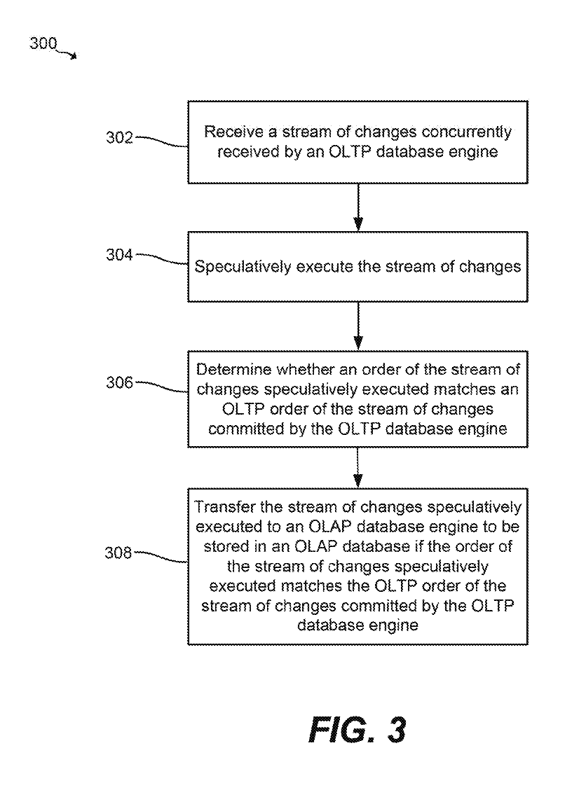

FIG. 3 is a flowchart illustrating an example method 300 of speculatively executing of a stream of changes. Method 300 may be implemented using computing device 200 of FIG. 2.

Method 300 includes, at 302, receiving a stream of changes concurrently received by an OLTP database engine. The stream of changes may include any changes to be applied to the OLTP database, such as updates, insertions, deletions, and the like.

Method 300 also includes, at 304, speculatively executing the stream of changes. The stream of changes may be speculatively executed in any suitable manner. For example, the stream of changes may be speculatively executed based on a concurrency control scheme of the OLTP database engine.

Method 300 also includes, at 306, determining whether an order of the stream of changes speculatively executed matches an OLTP order of the stream of changes committed by the OLTP database engine. For example, if the OLTP database engine processes a stream of changes in a particular order that is the same as the order in which changes were speculatively executed, the speculatively executed changes may be validated.

Method 300 also includes, at 308, transferring the stream of changes speculatively executed to an OLAP database engine to be stored in an OLAP database if the order of the stream of changes speculatively executed matches the OLTP order of the stream of changes committed by the OLTP database engine. For examples, if the speculatively executed stream of changes is validated, the changes may be sent to the OLAP database engine such that the changes may be stored in the OLAP database.

Examples provided herein (e.g., methods) may be implemented in hardware, software, or a combination of both. Example systems may include a controller/processor and memory resources for executing instructions stored in a tangible non-transitory medium (e.g., volatile memory, non-volatile memory, and/or machine-readable media). Non-transitory machine-readable media can be tangible and have machine-readable instructions stored thereon that are executable by a processor to implement examples according to the present disclosure.

An example system can include and/or receive a tangible non-transitory machine-readable medium storing a set of machine-readable instructions (e.g., software). As used herein, the controller/processor can include one or a plurality of processors such as in a parallel processing system. The memory can include memory addressable by the processor for execution of machine-readable instructions. The machine-readable medium can include volatile and/or non-volatile memory such as a random access memory (“RAM”), magnetic memory such as a hard disk, floppy disk, and/or tape memory, a solid state drive (“SSD”), flash memory, phase change memory, and the like.

What is claimed is:

1. A computing device comprising:
at least one processor to:
receive a stream of changes concurrently received by an online transaction processing (OLTP) database engine in communication with the computing device;
process the stream of changes based on speculative execution;
verify that an order of the stream of changes processed based on speculative execution matches an OLTP order of the stream of changes committed by the OLTP database engine; and
send the stream of changes processed based on speculative execution to an online analytical processing (OLAP) database engine to be stored in an OLAP database.

2. The computing device of claim 1, wherein the speculative execution is based on a concurrency control scheme of the OLTP database engine.

3. The computing device of claim 1, wherein the computing device includes the OLAP database engine.

4. The computing device of claim 1, wherein the OLAP database engine is separate from the computing device.

5. The computing device of claim 1, wherein the stream of changes includes at least one of an update operation, an insert operation, and a delete operation.

6. The computing device of claim 1, wherein the at least one processor is further to:
determine that the order of the stream of changes processed based on speculative execution does not match the OLTP order of the stream of changes committed by the OLTP database engine; and
reprocess the stream of changes based on the OLTP order of the stream of changes.

7. A method comprising:
receiving, by a computing device, a stream of changes concurrently received by an online transaction processing (OLTP) database engine in communication with the computing device;
speculatively executing, by the computing device, the stream of changes;
determining, by the computing device, whether an order of the stream of changes speculatively executed matches an OLTP order of the stream of changes committed by the OLTP database engine; and
transferring, by the computing device, the stream of changes speculatively executed to an online analytical processing (OLAP) database engine to be stored in an OLAP database if the order of the stream of changes speculatively executed matches the OLTP order of the stream of changes committed by the OLTP database engine.

8. The method of claim 7, wherein the stream of changes is speculatively executed based on a concurrency control scheme of the OLTP database engine.

9. The method of claim 7, wherein the computing device includes the OLAP database engine.

10. The method of claim 7, wherein the OLAP database engine is separate from the computing device.

11. A non-transitory machine-readable storage medium storing instructions that, if executed by at least one processor of a computing device, cause the computing device to:
receive a stream of changes concurrently received by an online transaction processing (OLTP) database engine in communication with the computing device;
speculatively execute the stream of changes;
confirm that an order of the stream of changes speculatively executed matches an OLTP order of the stream of changes committed by the OLTP database engine; and
commit the stream of changes speculatively executed to an online analytical processing (OLAP) database via an OLAP database engine.

12. The non-transitory machine-readable storage medium of claim 11, wherein the stream of changes is speculatively executed based on a concurrency control scheme of the OLTP database engine.

13. The non-transitory machine-readable storage medium of claim 11, wherein the computing device includes the OLAP database engine.

14. The non-transitory machine-readable storage medium of claim 11, wherein the OLAP database engine is separate from the computing device.

15. The non-transitory machine-readable storage medium of claim 11, wherein the stream of changes includes at least one of an update operation, an insert operation, and a delete operation.
